(19) United States
(12) Patent Application Publication
(10) Pub. No.: US 2026/0220119 A1
(43) Pub. Date: Jul. 30, 2026

(54) AUTOMATIC DOCUMENT CONTENT SEARCH AND REPLACE FOR DOCUMENTS WITH MATCHING METADATA METHODS

(71) Applicant: KYOCERA DOCUMENT SOLUTIONS, INC., Osaka (JP)

(72) Inventor: Selim ZAMAN, San Mateo, CA (US)

(73) Assignee: KYOCERA DOCUMENT SOLUTIONS, INC., Osaka (JP)

(21) Appl. No.: 19/037,607

(22) Filed: Jan. 27, 2025

(51) Int. Cl. G06F 16/23; G06F 16/903; G06F 16/93

(52) U.S. Cl. CPC G06F 16/2358; G06F 16/90335; G06F 16/93

(57) ABSTRACT

An automatic document content search and replacement for documents with a matching metadata system receives a plurality of documents imported using an optical character recognition (OCR) device. The methods enter a change to the content in a document and filter a plurality of documents in a database with metadata. The methods search matched documents and further search the document content in the matched documents. The methods request the change to the content and determine whether the requested change meets a simple change criterion. The method updates the matched document. The methods determine whether a document change is simple or complex criterion based on the document database user's preset standard. The methods also change the content of a document for a change request that falls within complex criterion by reporting the change to document owners before enforcement.

### FIELD OF THE INVENTION

The present invention relates methods for automatically searching and replacing document contents for a document with matching document metadata. More particularly, the present invention relates to an automated document update process where the same update is applicable to a plurality of documents belonging to the same document class as specified in the document metadata.

### DESCRIPTION OF THE RELATED ART

Users with a large number of documents stored in the storage database sometimes encounter a situation where multiple documents in a similar document class require the same updates, such as updates to address fields, date fields, contractual clauses, the company logo, typographical corrections, and the like.

When a large number of documents require such modification, making these changes manually can become cumbersome. Furthermore, while making such a change, a change complexity criteria depends on users since some uses of document databases require sensitive consideration regarding modification.

### SUMMARY OF THE INVENTION

A method for automatically searching document content and updating at least one document is disclosed. The method also includes entering a change to a content in a document in a database. The method also includes filtering a plurality of documents in the database with metadata. The method also includes searching a matched document with matching metadata. The method also includes searching the content in the matched document. The method also includes requesting the change to the content in the matched document. The method also includes determining the change to be made meets a simple change criterion. The method also includes updating the matched document with the change. The method also includes storing the updated matched document in the database. The method also includes reporting the update of the matched document to a document owner of the matched document.

A method for determining a document change complexity criterion is disclosed. The method also includes presetting a document change complexity criterion to conform with a use of a document owner of a document database. The method also includes defining a metadata applicable for a plurality of documents in a database. The method also includes entering the metadata to filter the plurality of documents in a database. The method also includes searching a metadata in the plurality of documents in the database with the metadata parameter. The method also includes finding a matched metadata having the metadata in the plurality of documents in the database. The method also includes generating the matched documents based on the matched metadata. The method also includes updating a content within the matched documents with a change as requested by a requester. The method also includes determining a complexity of the change by applying the document change complexity criterion. The method also includes performing the change without reporting when the complexity of the change is a simple change. The method also includes reporting the change before performing the change when the complexity of the change is a complex change.

A method for automatically searching document content and updating at least one document is disclosed. The method also includes entering a change to a content in a document in a database. The method also includes filtering a plurality of documents in the database with metadata. The method also includes searching a matched document with matching metadata. The method also includes searching the content in the matched document. The method also includes requesting the change to the content in the matched document. The method also includes determining the change to be made does not meet a simple change criterion. The method also includes notifying a document owner of the matched document about the change. The method also includes changing the content in the matched document based on the request when the change is approved by the document owner. The method also includes updating the matched document with the change. The method also includes storing the updated matched document in the database.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps may be rearranged, combined, distributed, eliminated, or otherwise changed, while remaining within the scope of the disclosed embodiments.

### BRIEF DESCRIPTION OF THE DRAWINGS

Various other features and attendant advantages of the present invention will be more fully appreciated when considered in conjunction with the accompanying drawings.

FIG. 1 illustrates a block diagram of a document content search and replacement system according to the disclosed embodiments.

FIG. 2 illustrates an OCR device according to the disclosed embodiments.

FIG. 3 illustrates a flow chart for the end-to-end system workflow for automatically searching document content and replacing the system with a simple change criterion according to the disclosed embodiments.

FIG. 4 illustrates a flow chart for the end-to-end system workflow for determining a document change complexity criterion according to the disclosed embodiments.

FIG. 5 illustrates a flow chart for the end-to-end system workflow for automatically searching document content and replacing the system with a complex change criterion according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide a mechanism to efficiently update documents in a cloud storage of the document management system. The disclosed embodiments also provide a method of determining a document change complexity criterion that was presented by a document owner.

Users of a document storage database sometimes need to update multiple documents in a similar document class with the same changes, such as updates to address fields, date fields, contractual clauses, company logos, typographical corrections, and the like. Change content may be plain or formatted text, fields with specific formats (such as date fields), logos, embedded images, and the like.

Making these changes manually can be time consuming. The disclosed embodiments provide a mechanism to automatically search for relevant documents and make the updates to all documents as provided by the user. The disclosed embodiments also provide an automated document update process where the same update is applicable to plurality of documents belonging to the same document class as specified in the document metadata. The disclosed embodiments also provide a mechanism to automatically search and update of specified the contents in plurality of documents.

The change requester provides document metadata based on which other documents are searched for throughout the storage database in all folders. Metadata for document search can be a combination of multiple document classes or attributes to extract documents belonging to the same document class, e.g., same client, same year of document creation, same address, same dates, same owner, and the like. When the documents are identified, a further content search is done in each document to find the matching content requiring an update as specified by the change requester. The original text is then replaced with the text provided by the user in the content update data file. Text and image matching software is used to search for the same content in documents.

Depending on the complexity of the changes, measured against a change complexity criterion set for each document owner, the affected document owners are prompted to confirm the updates made to their documents. Change complexity criteria are specified per document owner, set by an admin or hardcoded based on region or customer industry, even though end user cannot configure them. The reason is some companies may require strict change control on their documents, such as in the legal, insurance, or healthcare industry, whereas some may be more casual about change control, such as small businesses. The change criteria differentiate between simple (small) and complex (major) changes. Simple changes are like typographical or grammatical errors, i.e., changes to a single word or punctuation. Complex changes are semantic changes to paragraphs or changes to images or data tables. For example, for simple changes, the requester is able to make bulk changes to all documents. The changed documents are then stored back in the database in an updated version, with version history updated accordingly.

Document owners receive notifications when changes are made to their documents. The solution is provided through an automated software system integrated into the document cloud platform. The system comprises proprietary, as well as third party, software components.

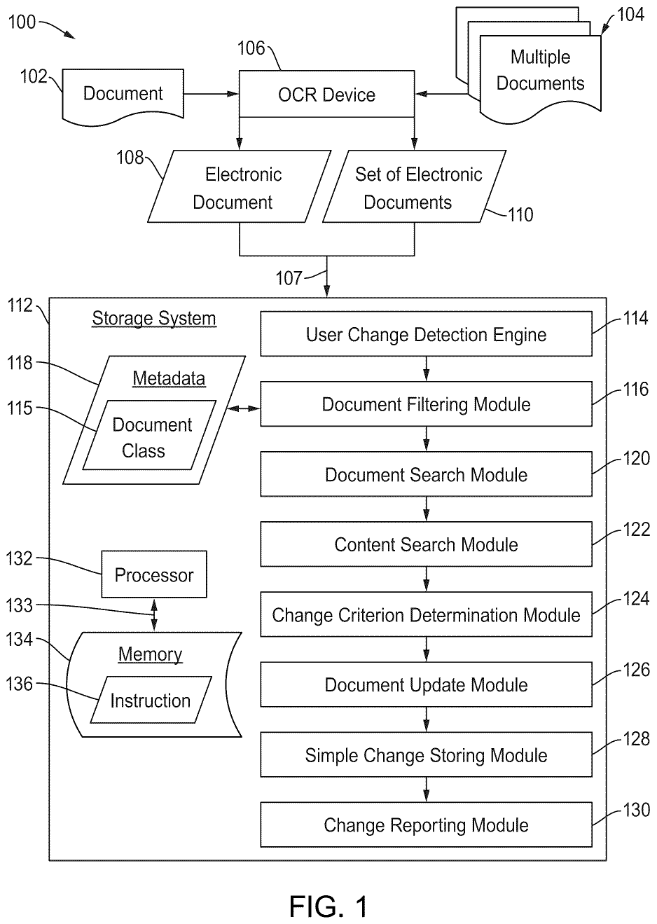

FIG. 1 depicts a block diagram of a document content search and replacement system 100 according to the disclosed embodiments. Document content search and replacement system 100 may receive large batches of documents, process them, and manage their access and use in operations. As part of this, document management system 100 uses a storage system 112 that stores documents that have been received and processed within system 100. One feature of the processing may be scanning or importing batches of documents by optical character recognition (OCR) device 106.

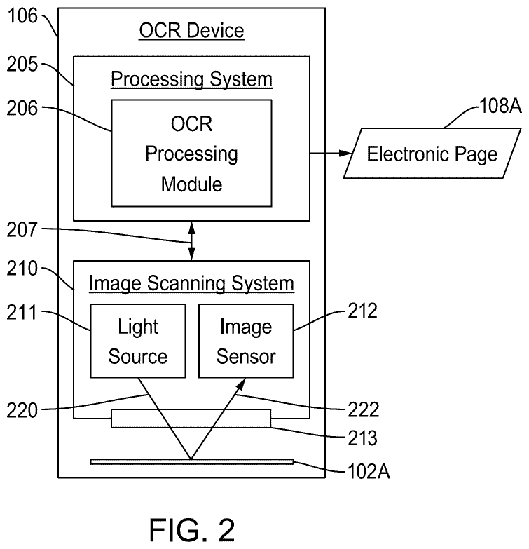

OCR device 106 is communicatively coupled to storage system 112 within system 100. OCR device 106 may be connected to storage system 112 over network 107. OCR device 106 may be within a printing device, a scanner, a computing device, a web client, and the like. OCR device 106 is disclosed in greater detail below in FIG. 2. Within system 100, OCR device 106 helps with the importation of large batches of documents, such as records, books/texts, forms, or other data that is in a document that is captured electronically to be managed using storage system 112.

For example, a contract document 102 is drafted by a business with the abbreviated name KDDA. The contract document belongs to a document class called Contract with attribute fields of year, region, company name and account manager. The documents with the same content but different metadata are placed in different folders belonging to respective account managers in a region. OCR device 106 captures images of the records to generate an electronic document 108. An electronic document 108 is the electronic or image version of document 102. Electronic document 108 may include images having pixels to represent the characters and graphics within the first set of documents 102. OCR device 106 imports document 102 into system 100 by processing them.

Multiple documents 104 also may be imported into system 100 using OCR device 106. Multiple documents 104 may be company records kept on paper for the past several years. These records also may include different formats and even different languages. OCR device 106 captures multiple documents 104 to generate a set of electronic documents 110. Set of electronic documents 110 also may include images having pixels that represent the characters and graphics within multiple documents 104.

Document 102 and multiple documents 104 include a business with the abbreviated name KDDA which is provided for the document itself or some text. The abbreviated name KDDA is not necessarily in the same place within each document. Further, the format used for the abbreviated name KDDA field may vary. The characters used in the abbreviated name KDDA fields may also be used in different colors or sizes.

Afterward, following an internal review, it was decided the contract should have been written on behalf of the parent organization KDC for the region of Japan, and not KDDA. So, there is a simple naming mistake in the multitude of documents stored under different folders targeted at Japanese customers. With the disclosed embodiments, the user can perform the change by updating the configuration file to classify a single word change as a simple change and the other configuration file to replace KDDA with KDC in all documents intended for Japanese customers in the year 2024.

When the change is entered, user change detection engine 114 recognizes the input and then sends to document filtering module 116 to match with metadata 118 and the document class 115 of the metadata 118. Then, document search module 120 and content search module 122 accumulate the documents that need to be changed. After the initiation of change criterion determination module 124, document update module 126 also initiates and the system recognizes the change as simple (because it is only a single word change), then looks for the metadata 118 of documents for the region Japan and the year 2024. For each identified document, it goes through the content looking for KDDA, then replaces it with KDC, using a simple search and replace algorithm. Afterwards, a simple change storing module 128 initiates and saves the documents. Processor 132 is connected to memory storage 134 by data bus 133. Memory storage 134 includes instructions 136. Instructions 136 may be code that, when read by processor 132, configures storage system 112 to perform the operations disclosed herein.

FIG. 2 depicts OCR device 106 according to the disclosed embodiments. OCR device 106 receives a page or document 102A of document 102. Further pages may be loaded after processing of page 102A is complete. OCR device 106 includes an image scanning system 210 communicatively coupled to a processing system 205 via a communications link 207. Communications link 207 may be a wire, a communications cable, a wireless link, or a metal track on a printed circuit board.

Image scanning system 210 includes a light source 211 that projects light 220 through a transparent window 213 to strike a surface of page 102A. Page 102A, which may be a sheet of paper containing text or graphics, reflects light 220 towards an image sensor 212. Image sensor 212 contains light sensing elements, such as photodiodes or photocells, and converts received light 222 into electrical signals that are transmitted to OCR processing module 206 within processing system 205. The electrical signals may be digital bits.

Processing system 205 generates electronic page 108A from the captured data for page 102A. Electronic page 108A is included in one of the electronic documents within electronic document 108. In some embodiments, OCR device 106 is a slot scanner incorporating a linear array of photocells. OCR processing module 206 that is a part of processing system 205 may be used to operate upon the electrical signals for performing optical character recognition of text and graphics printed on page 102A.

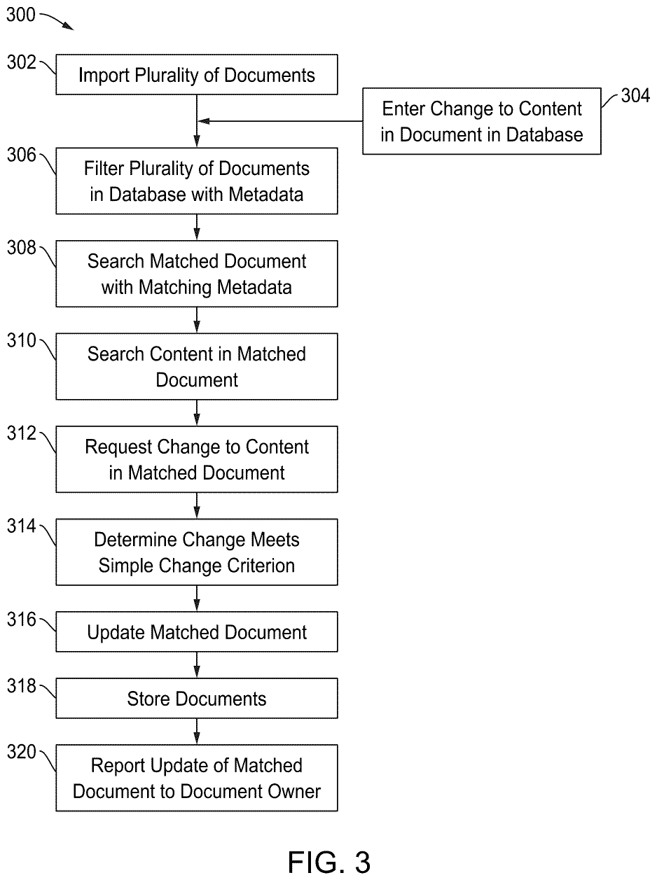

FIG. 3 illustrates a flow chart 300 for the end-to-end system workflow for automatically searching document content and replacing system with simple change criterion according to the disclosed embodiments. Flowchart 300 may refer to FIGS. 1-2 for illustrative purposes. Flowchart 300, however, is not limited by the embodiments disclosed by FIGS. 1-2.

Step 302 executes by importing a plurality of documents into storage system 112 using OCR device 106. For example, document 102 may be scanned by OCR device 106 to generate first set of electronic documents 108. A plurality of documents may be scanned to import a large set of documents, such as 100s or 1000s of documents at once.

Step 304 executes by entering a change to a content in a document in a database by a user. For example, the change could be such as updates to address fields, date fields, contractual clauses, company logo, typographical corrections, and the like. Step 306 executes by filtering a plurality of documents in the database with metadata 118. Then, Step 308 executes by searching a matched document with matching metadata. For example, an address in a plurality of documents in the database needs to be updated, then document filtering module 116 filters documents with a document class 115 of address metadata 118 and executes document search module 120. Once documents are searched, then the content search module 122 takes part in and finds the portion of the address.

Step 310 executes by searching the content in the matched document by using the processor 132 and memory storage 134 including instructions 136. Step 312 executes by requesting the change to the content in the matched document by using the processor 132 and memory storage 134 including instructions 136. Step 314 executes determine the change to be made meets a simple change criterion by using the processor 132 and memory storage 134 including instructions 136. Step 316 executes by updating the matched document by using the processor 132 and memory storage 134 including instructions 136. Step 318 executes by storing the documents by using the processor 132 and memory storage 134 including instructions 136. Step 320 executes by reporting the update of the matched document to the document owner by using the processor 132 and memory storage 134 including instructions 136. For example, with the change reporting module 130, the document owners (account managers from the metadata) receive an email and pop-up notification that the document has been modified; modification details can then be found in version history.

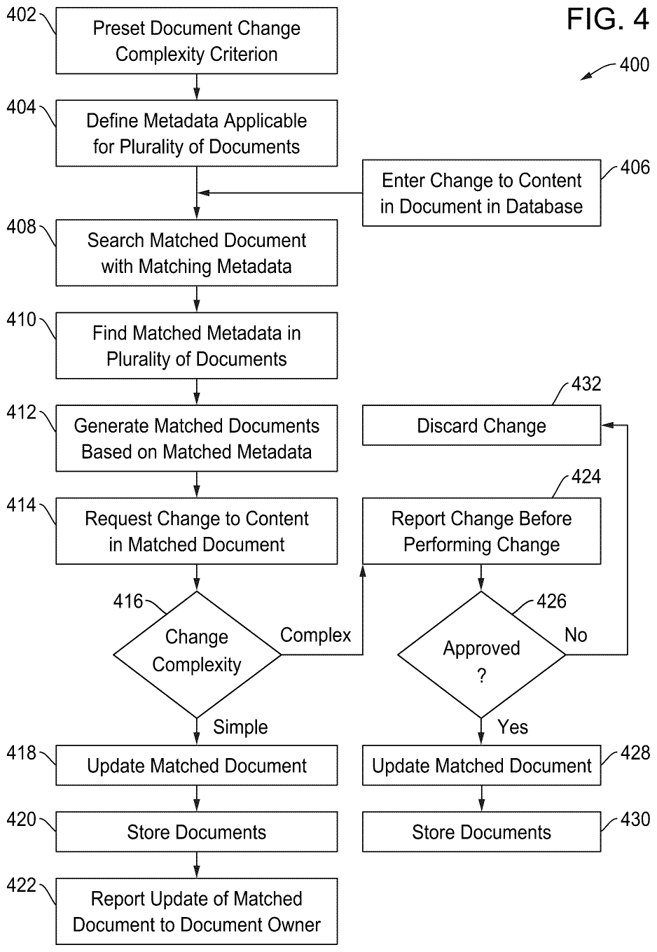

FIG. 4 illustrates a flow chart 400 for the end-to-end system workflow for determining a document change complexity criterion according to the disclosed embodiments. Flowchart 400 may refer to FIGS. 1-3 for illustrative purposes. Flowchart 400, however, is not limited by the embodiments disclosed in FIGS. 1-3.

Step 402 executes by presetting a document change complexity criterion set by a document owner for the use of the document database. For example, the document owner may use the database for product lists, contract documents, medical diagnosis records, and the like. Depending on the purpose of the use, the complexity criterion differs from the document database. To give flexibility for the complexity criterion, the document owner can arbitrarily determine the document change complexity criterion.

Step 404 executes by define a metadata applicable for within one or more electronic documents of document 108. For example, each page of each document may be analyzed by document filtering module 116, to identify a metadata 118 within one or more pages of the document.

Step 406 executes by entering a change to a content in the electronic document electronic document 108. For example, user change detection engine 114 may find the change inputted by the user. Step 408 executes by searching a matched document with matching metadata 118. For example, metadata 118 may be the pre-created within the storage system 112 and set by the user, the administrator of the imported documents, and the like.

Step 410 executes by find a matched metadata in the set of electronic documents 110. For example, if the requested change is related to a product name, documents with metadata 118 of product name will be pulled out from the set of electronic documents 110.

Step 412 executes by generating the matched documents with based on the matched metadata by using the processor 132 and memory storage 134 includes instructions 136. Step 414 executes by requesting the change to the content in the matched document by using the processor 132 and memory storage 134 including instructions 136.

Step 416 executes by determining complexity of the change. For example, following the document change complexity criterion preset by the document owner in Step 402, Step 416 determine whether the complexity of the change is simple change or complex change. When Step 416 determines the complexity of the change is simple change, Step 418 proceeds and executes updating the matched document. Then, Step 420 executes storing documents and Step 422 executes reporting the update of the matched document to a document owner. For example, Steps 418 to 422 processed a simple change automatically by updating two configuration files and initiating the change which is completed automatically without any approval process before making the change. When Step 416 determines the complexity of the change is complex change, Step 424 proceeds and executes reporting the change before performing the change by the document owner. Upon approval by document owner, Step 428 executes by updating the matched document and Step 430 executes by storing documents. For example, Steps 424 to 426 processed a complex change by updating two configuration files and initiating the change which is completed with approval process before making the change. If the change was not approved by the document owner 426, Step 432 executes by discarding the change.

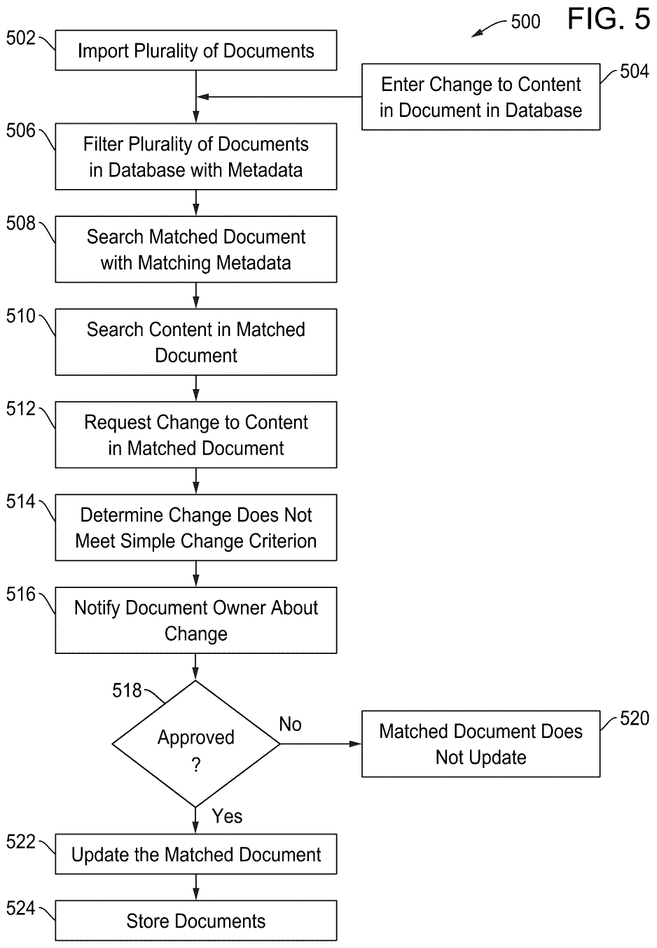

FIG. 5 illustrates a flow chart for the end-to-end system workflow for automatically searching document content and replacing system with complex change criterion according to the disclosed embodiments. Flowchart 500 may refer to FIGS. 1-4 for illustrative purposes. Flowchart 500, however, is not limited by the embodiments disclosed by FIGS. 1-4.

Step 502 executes by importing a plurality of documents into storage system 112 using OCR device 106. For example, document 102 may be scanned by OCR device 106 to generate first set of electronic documents 108. A plurality of documents may be scanned to import a large set of documents, such as 100s or 1000s of documents at once.

Step 504 executes by entering a change to a content in a document in a database by a user. For example, the change could be such as updates to address fields, date fields, contractual clauses, company logo, typographical corrections, and the like. Step 506 executes by filtering a plurality of documents in the database with metadata 118. Then, Step 508 executes by searching a matched document with matching metadata. For example, an address in a plurality of documents in the database needs to be updated, then document filtering module 116 filters documents with a document class 115 of address metadata 118 and executes document search module 120. Once documents are searched, then the content search module 122 takes part in and finds the portion of the address.

Step 510 executes by searching the content in the matched document. Step 512 executes by requesting the change to the content in the matched document. Step 514 executes to determine the change to be made does not meet a simple change criterion. Step 516 executes by notifying a document owner about the change. For example, if the required change is more complex, such as actual semantic change in the contract description, then the same process will be followed to identify the content sections where changes are to be applied; however, after that, instead of making the change, as it is a complex change (based on metadata definition of complexity which classifies only single word change as simple, everything else complex), the system sends email and pop-up alerts to respective account managers (document owners) to approve the change.

In Step 518, the document owner determines whether the change is approved or not. For example, the document owner can approve the automatic change or reject it in preference of doing the update themselves. When Step 518 does not approve the change, proceed to Step 520 and do not update the matched document. When Step 518 approves the change, Step 522 executes by updating the matched document and Step 524 executes by storing documents. For example, if the document owner accepts the change, the system proceeds to make the change and notify the document requester and owners that the change has been implemented. The above is an example of a complex change processed automatically by updating two configuration files to initiate upon approval of the document owner. This capability to automatically update multiple documents in a few steps would be a useful feature for document database systems with a large customer base.

As will be appreciated by one skilled in the art, the present invention may be embodied as a system, method or computer program product. Accordingly, the present invention may take the form of an entirely hardware embodiment, an entirely software embodiment (including firmware, resident software, micro-code, and the like.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for automatically searching document content and updating at least one document, the method comprising:
entering a change to a content in a document in a database;
filtering a plurality of documents in the database with metadata;
searching a matched document with matching metadata;
searching the content in the matched document;
requesting the change to the content in the matched document;
determining the change to be made meets a simple change criterion being a document change complexity criterion set by an administrator;
updating the matched document with the change;
storing the updated matched document in the database; and
reporting the update of the matched document to a document owner of the matched document.

2. The method of claim 1, further comprising importing the plurality of documents into the database, wherein the plurality of documents contains the metadata.

3. The method of claim 1, wherein the metadata is a combination of a plurality of document classes or document attributes.

4. The method of claim 1, wherein the simple change is a single word change.

5. The method of claim 1, further comprising skipping the reporting step when a requester and the document owner are the same.

6. The method of claim 1, further comprising requesting the change to the content in a set of matched documents.

7. A method for determining a document change complexity criterion, the method comprising:
presetting a document change complexity criterion set by an administrator to conform with a use of a document owner of a document database;
defining a metadata applicable for a plurality of documents in a database;
entering the metadata to filter the plurality of documents in a database;
searching a metadata in the plurality of documents in the database with a metadata parameter;
finding a matched metadata having the metadata in the plurality of documents in the database;
generating the matched documents based on the matched metadata;
updating a content within the matched documents with a change as requested by a requester;
determining a complexity of the change by applying the document change complexity criterion;
performing the change without reporting when the complexity of the change is a simple change; and
reporting the change before performing the change when the complexity of the change is a complex change.

8. The method of claim 7, wherein the document change complexity criterion includes one of a simple change criterion or a complex change criterion.

9. The method of claim 8, further comprising determining whether the change to be made in the content is categorized as the simple change criterion or the complex change criterion.

10. The method of claim 7, wherein the document change complexity criterion is defined by a document owner.

11. The method of claim 7, wherein the document change complexity criterion is hardcoded into the database system.

12. The method of claim 8, further comprising updating the change to be made in the content for the simple change criterion.

13. A method for automatically searching document content and updating at least one document, the method comprising:
entering a change to a content in a document in a database;
filtering a plurality of documents in the database with metadata;
searching a matched document with matching metadata;
searching the content in the matched document;
requesting the change to the content in the matched document;
determining the change to be made does not meet a simple change criterion being a document change complexity criterion set by an administrator;
notifying a document owner of the matched document about the change;
changing the content in the matched document based on the request when the change is approved by the document owner;
updating the matched document with the change; and
storing the updated matched document in the database.

14. The method of claim 13, further comprising importing the plurality of documents into the database, wherein the plurality of documents contain metadata.

15. The method of claim 13, wherein the metadata is a combination of a plurality of document classes or document attributes.

16. The method of claim 13, further comprising a document owner review for the change is conducted by a plurality of document owners.

17. The method of claim 16, further comprising if a first document owner rejected the change to be made, notifying a second document owner in charge of the document owner review of the rejected change.

18. The method of claim 16, further comprising updating the change to be made in the content when one of the pluralities of document owners accepted the change.

19. The method of claim 13, further comprising skipping the reporting step when a requester and the document owner are the same.

20. The method of claim 13, further comprising requesting the change to the content in a set of matched documents.
